(19) United States
(12) Patent Application Publication
(10) Pub. No.: US 2008/0041798 A1
(43) Pub. Date: Feb. 21, 2008

(54) Wafer Platform

(75) Inventors: Brian L. Gilmore, O'Fallon, MO (US); Larry W. Shive, St. Charles, MO (US)

Correspondence Address: SENNIGER POWERS, ONE METROPOLITAN SQUARE, 16TH FLOOR, ST LOUIS, MO, 63102, US

(73) Assignee: MEMC ELECTRONIC MATERIALS, INC., St. Peters, MO (US)

(21) Appl. No.: 11/767,198

(22) Filed: Jun. 22, 2007

Related U.S. Application Data
(60) Provisional application No. 60/806,377, filed on Jun. 30, 2006.

(51) Int. Cl. B05C 13/00; A47G 19/08

(52) U.S. Cl. 211/41.18; 118/500; 414/938

(57) ABSTRACT

A platform for supporting a semiconductor wafer includes a body with channel having spaced apart first and second edge margins in contiguous relationship with a top surface of the body. At least one of the edge margins is generally convex along at least a portion of the channel.

### CROSS-REFERENCE TO RELATED APPLICATION

The present application claims priority to U.S. Provisional Application No. 60/806,377 filed Jun. 30, 2006, the entirety of which is herein incorporated by reference in its entirety.

### FIELD OF THE INVENTION

The present invention relates generally to a platform for supporting a wafer, and more specifically to such a platform having a channel with at least one edge being convex.

### BACKGROUND OF THE INVENTION

High temperature heat treatment (e.g., annealing) of semiconductor wafers is commonly used to achieve certain desirable characteristics. During high temperature heat-treatment, at temperatures above 750° C. and especially above 1100° C., the silicon wafers become more plastic. If the silicon wafers are not adequately supported during heat treatment, the wafers may undergo slip due to local gravitational and thermal stresses. As is well known in the art, slip may introduce contaminants into the device areas of the wafers. Moreover, excessive slip may lead to plastic deformation of the wafers, which in turn may lead to production problems, such as photolithography overlay failures causing yield losses in device manufacture.

A vertical furnace may be used for the annealing process. Typically, a wafer boat is used to support a relatively large number of wafers (e.g., 90 to 135 wafers) in the vertical furnace. The wafer boat functions as a rack, and, ideally, minimizes the local gravitational and thermal stresses on the wafers to avoid slip and plastic deformation while the wafers are being heat treated. A typical vertical wafer boat used in a vertical furnace comprises three or more vertical rails also referred to as rods. The rods typically have grooves or laterally extending fingers for supporting wafer holder platforms, e.g., a ring or solid plate, between the vertical rods within the boat. Each wafer may rest on a single wafer holder platform for supporting the wafer in an attempt to decrease the amount of local gravitational and thermal stresses subjected on the wafer during treatment. The wafer holder platform may include a groove or channel in a top surface of the platform to prevent the wafer from “floating” on the ring during wafer loading and to prevent the wafer from sticking to the platform during unloading.

### SUMMARY OF THE INVENTION

In one embodiment, a platform for supporting a semiconductor wafer comprises a body having a generally planar top surface sized and shaped for supporting the wafer. A channel runs along the top surface of the body and has a depth extending from the top surface toward the bottom surface of the body. The channel has spaced apart first and second edge margins in contiguous relationship with the top surface of the body. At least one of the edge margins is generally convex along at least a portion of the channel.

In another embodiment, a support ring for supporting a semiconductor wafer in a vertical wafer boat during an annealing process comprises a generally ring-shaped body sized and shaped for reception in the vertical wafer boat and having a generally planar top surface sized and shaped for supporting the wafer and a bottom surface. A channel runs along the top surface of the body and has a depth extending from the top surface toward the bottom surface of the body. The channel has radially spaced apart inner and outer edge margins in contiguous relationship with the top surface of the body. At least one of the inner and outer edge margins is generally convex.

### BRIEF DESCRIPTION OF THE DRAWINGS

FIG. 1 is a perspective of one embodiment of a support ring for supporting a semiconductor wafer in a vertical wafer boat during high temperature annealing;

FIG. 2 is a perspective of a vertical wafer boat holding a plurality of support rings;

FIG. 3 is a cross-section of the support ring through a groove of the support ring taken in a plane containing the line 3-3 of FIG. 1;

FIG. 4 is an enlarged view of a portion of the groove of the support ring of FIG. 3 including a left edge margin of the groove;

FIG. 5 is an enlarged cross-sectional view of a portion of a support ring having a groove with broken edge margins, the portion including the left edge margin of the groove;

FIG. 6 is a graphical representation of slip present in a wafer that was supported by a support ring like that of FIG. 5 having a groove with broken edge margins during high temperature annealing;

FIG. 7 is an enlarged cross-sectional view of a portion of a support ring having a groove with 2 degree chamfered, polished edge margins, the portion including the left edge margin of the groove;

FIG. 8 is a graphical representation of slip present in a wafer that was supported by a support ring like that of FIG. 8 having a groove with 2 degree chamfered, polished edge margins during high temperature annealing;

FIG. 9 is a graphical representation of slip present in a wafer that was supported by a support ring having a groove with 2 degree, unpolished chamfered edge margins during high temperature annealing;

FIG. 10 is an enlarged cross-sectional view of a portion of a support ring having a groove with convex edge margins having 0.1 mm radii of curvature, the portion including the left edge margin of the groove;

FIG. 11 is a graphical representation of slip present in a wafer that was supported by a support ring having a groove with edge margins having 0.1 radii of curvature during high temperature annealing; and

FIG. 12 is a graphical representation of slip, or lack thereof, present in a wafer that was supported by a support ring having a groove with edge margins having 0.5 mm radii of curvature during high temperature annealing; and

Corresponding reference characters indicate corresponding parts throughout the drawings.

### DETAILED DESCRIPTION OF THE DRAWINGS

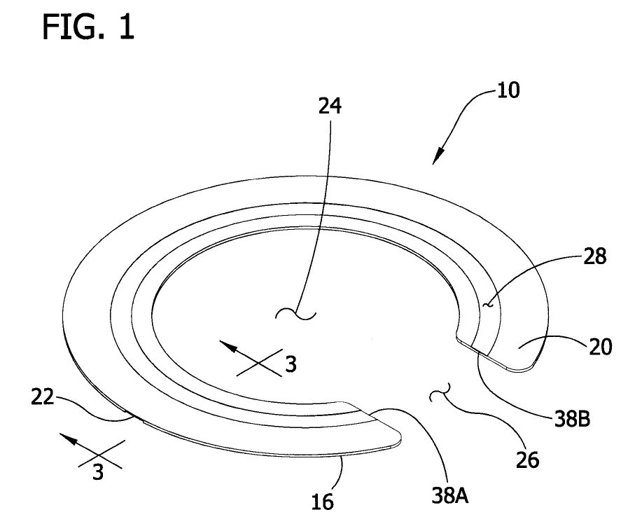

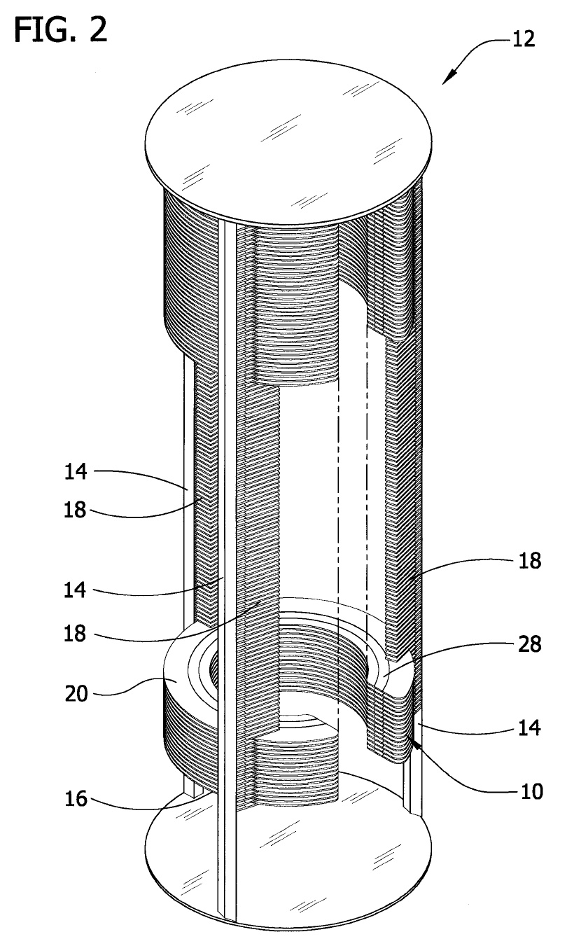

Referring now to the Figures, and in particular to FIGS. 1 and 2, a wafer support platform is generally indicated at reference numeral 10. As shown in FIG. 2, the illustrated wafer support platform is of the type sized and shaped to be received in a vertical wafer boat, generally indicated at 12, for supporting a semiconductor wafer W during high temperature annealing in a vertical furnace. The platform 10 is arcuate and is sized and shaped to be received between rails 14 of the vertical wafer boat 12. A bottom surface 16 of the platform 10 rests on fingers 18 extending from the rails 14 of the wafer boat 12 while a top surface 20 of the platform supports a single wafer W thereon. The bottom surface 16 of the platform 10 may have grooves 22 (only one of which is illustrated in FIG. 1) formed therein for receiving the corresponding fingers 18 of the wafer boat 12. Such a configuration is described in detail in U.S. Pat. No. 7,033,168 issued Apr. 25, 2006, the entirety of which is herein incorporated by reference. It is understood that the wafer support platform 10 may be used in other types of wafer boats and holders for semiconductor wafers without departing from the scope of this invention.

Referring still to FIG. 1, the illustrated platform 10 is of an open-ring type, in that it has a large central hole 24 and a radial opening 26 extending from the hole to the outer periphery of the platform. This type of platform is referred to herein as a “support ring”. The support ring 10 may be constructed of silicon carbide (SiC), or other materials. The support ring 10 may have a diameter of about 200 mm or about 300 mm or other sizes, depending on the size of the wafer to be supported thereon. It is understood that the wafer support platform 10 may be of other configurations. For example, the platform 10 may be of a type for supporting a semiconductor in a structure other than a vertical furnace. Moreover, the platform 10 may be of another type besides an open-ring type. For example, the platform may be of a closed-ring type (i.e., not having a radial opening) or a substantially solid platform.

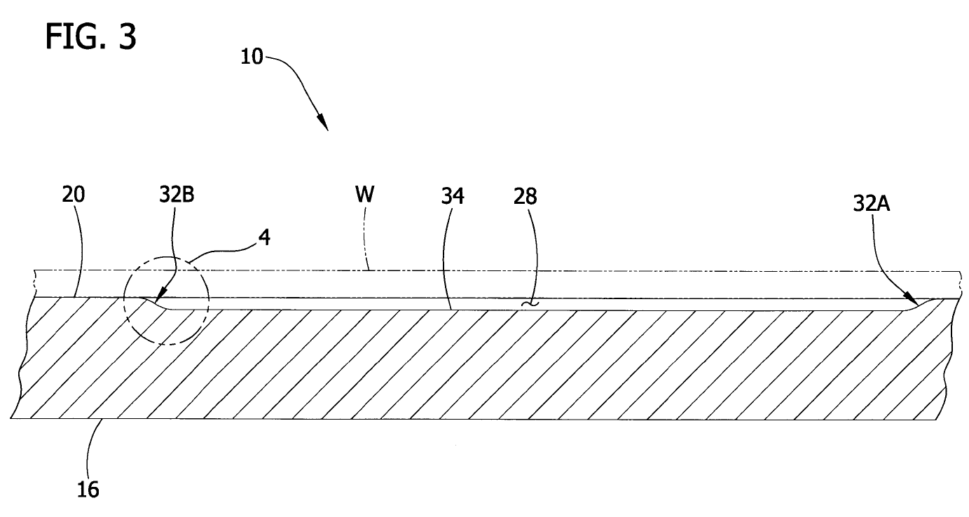

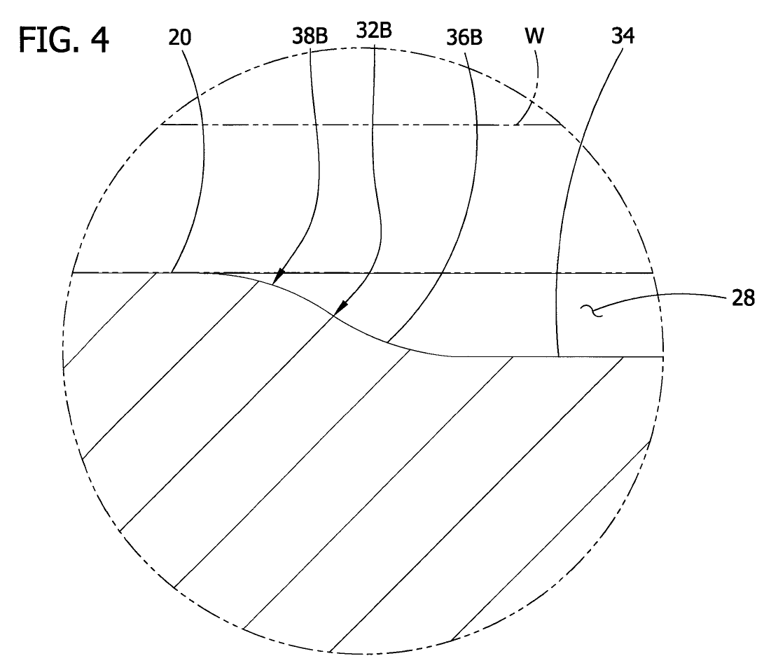

Referring now to FIGS. 1, 3 and 4, the wafer support ring 10 has an arcuate, concentric channel 28 running along the top surface 20 of the ring. As shown best in FIG. 1, the channel 28 has opposite open ends 38A, 38B, each of which extends through an opposing edge of the ring 10 defining the radial opening 26. Referring to FIG. 3, the channel 28 is defined by inner and outer side surfaces, generally indicated at 32A, 32B, respectively, (i.e., inner and outer in relation to a center of the ring) and a generally planar bottom surface 34 extending between the inner and outer side surfaces. It is understood that the bottom surface 34 may be other than planar. Each side surface 32A, 32B has a portion, more specifically a lower portion (only the lower portion 36B of the outer side surface is shown in FIG. 4) adjacent the bottom surface 34 34, that is substantially concave. It is understood that the use of position modifiers such as “lower”, “upper”, “inner” and “outer” are only with respect to the orientation of the embodiments as illustrated in the Figures and are not meant to be in any way limiting.

Referring to FIG. 4, the channel 28 has radially spaced apart inner and outer edge margins (only the outer edge margin is generally indicated at 38B in FIG. 4; the inner edge margin being substantially a mirror image). The inner and outer end margins 38B are in contiguous relationship with the top surface 20 and with respective inner and outer side surfaces 32A, 32B of the channel 28. It is understood that the inner and outer edge margins 38B may, and in most circumstances will, include portions of the top surface 20 and/or respective inner and outer side surfaces 32A, 32B, respectively, of the channel 28. This is because inner and outer edge margins 38B of the channel 28 include both inner and outer edges (i.e., where the top surface 20 and the respective side surfaces 32A, 32B meet) and the surfaces immediately adjacent to the edges, which may include the top surface and/or the side surfaces.

As shown best in FIGS. 3 and 4, the inner and outer edge margins 38B are generally convex. More specifically, the inner and outer edge margins 38B have a radius of curvature of about 0.5 mm. It is contemplated that the inner and outer edge margins 38B may have a radius of curvature less than or greater than 0.5 mm, without departing from the scope of this invention. For example, the inner and outer edge margins may have radii of curvature of about 0.1 mm or radii of curvature of about 1.0 mm. Also, each of the edge margins 38B is convex along substantially an entirety of the channel 28, although it is contemplated that the edge margins may be convex along only a portion of the channel. Moreover still, the inner and outer edge margins 38B each have a substantially uniform radius of curvature (e.g., 0.5 mm) along substantially the entirety of the channel, although it is contemplated that the radius of curvature may vary along the channel.

The inner and outer edge margins 38B are substantially uniformly spaced apart along the entire channel 28. For example, the edge margins may be spaced apart a distance of about 13 mm. The channel 28 may also have a uniform depth extending between the top surface 20 of the ring 10 and the bottom surface 34 of the channel 28. For example, the depth of the channel may be about 0.2 mm. It is understood that the distance between the edge margins 38B and/or the depth of the channel 28 may be other than given. It is also understood that the distance between the edge margins 38B and/or the depth of the channel 28 may vary along the channel.

As explained in more detail below, the inner and outer edge margins 38B of the channel 28, by virtue of them being convex, decrease the amount of slip in a wafer W being treated. Without being bound to a particular theory, it is believed that the wafer support platform 10 having a channel 28 with convex edge margins 38B, as opposed to a channel having either broken edge margins (i.e., a 90 degree edge) or even chamfered edge margins with a constant slope, reduce and in some instances eliminate slip because the edge margins gradually, as opposed to abruptly, fall away from a bottom surface of the wafer W resting on the wafer support platform. This gradual “falling away” applies more support to the wafer W at the edge margins 38B of the channel 28, and thus prevents point plastic deformation and slip in the supported wafer.

The channel 28 and/or the edge margins 38B and/or the side surfaces 32A, 32B of the channel may be formed by machining or any other suitable process.

Alternatively, or in addition to having a channel with generally convex edge margins, a silicon oxide layer may be formed on at least a portion of a silicon carbide (SiC) wafer support platform that contacts a silicon (Si) wafer to substantially prevent slip in the supported wafer. The silicon oxide layer may be formed by subjecting the SiC platform to a heat treatment in an oxidizing atmosphere. For example, the vertical wafer boat, including the platform but not including the wafers, may be placed in the vertical furnace in an oxidizing atmosphere to form the silicon oxide layer. After forming the oxide layer, the wafers then can be loaded in the boat and subjected to high temperature annealing. Each high temperature annealing process typically removes between about 25 nanometers and up to about 75 nanometers of the newly formed silicon oxide layer. Thus, the silicon oxide layer must be replenished after a certain number of batches depending on the thickness of the silicon oxide layer. It is preferable that the silicon oxide layer be at least about 25 nanometers thick, more preferably at least about 50 nanometers thick, and most preferably at least about 75 nanometers thick so that the silicon oxide layer is not completely removed during a single high temperature annealing process. A silicon oxide layer of up to about 5 μm may be formed on the wafer support platforms to increase the number of batches before replenishing the silicon oxide layer.

Oxidation of the SiC boat and SiC support platforms can be achieved by a dry oxidation process or by a wet oxidation process. The oxidizing atmosphere may comprise as low as about 1% by mole oxygen and as much as about 100% by mole oxygen. A silicon oxide layer of a thickness between at least the requisite minimum thickness of 25 nanometers and a thickness of about 5 μm can be produced by subjecting the silicon carbide structure to the oxidizing atmosphere for at least one hour and up to 36 hours, depending on oxygen concentration.

Without being bound to any particular theory, it is believed the silicon oxide layer acts as a lubricant between the surface of the SiC wafer support platform and the surface of the wafer as the respective surfaces move in relation to one another during heating. Because of the presence of this lubricant, the harder SiC material cannot scratch the backside of the softer Si wafer during thermal processing. If the oxide is not present, the differences in thermal expansion coefficients between SiC and Si can cause scratching during processing which can lead to dislocations and ultimately slip in the Si wafer.

### EXPERIMENTAL EXAMPLE

For the following experimental example, different wafer support platforms were used to support 300 mm wafers during a single annealing process to compare the amount of slip in the treated wafers. Each platform had a channel with a different side surface profile. Each platform was originally a solid CVD SiC 300 mm diameter ring. The platforms were machined to form the appropriate channel with the desired side surface profile. The platforms were supported within a 90 slot SiC vertical wafer boat with high purity CVD SiC film. The wafers were annealed in an A412 vertical furnace manufactured by ASM International and equipped with a high purity TSQ-20 quartz tube provided by Toshiba Ceramics. The annealing process consisted of a 1200° C. annealing for 1 hour in argon gas using optimized ramp rates to reduce slip. Ramp rates remained constant both before and after oxidation. After annealing the wafers were tested for surface slip using a Tencor SP-1 surface inspection station. This process was repeated so that four separate wafers were treated on each platform type during separate treatments. For each platform type, the slip or lack thereof that incurred in the treated wafers was substantially similar. In that respect, the slip graphs of the wafers illustrated are exemplary, and it is understood that the slip graphs of the other three wafers treated by the same platform type are substantially similar to the corresponding exemplary graph.

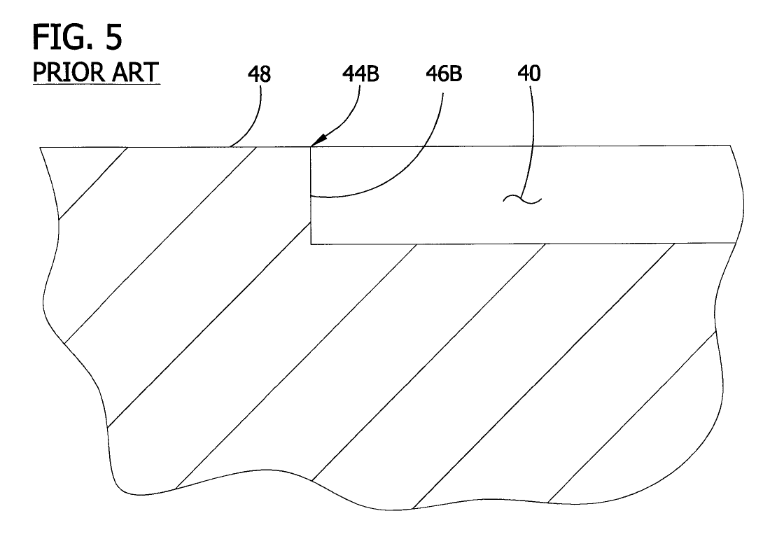

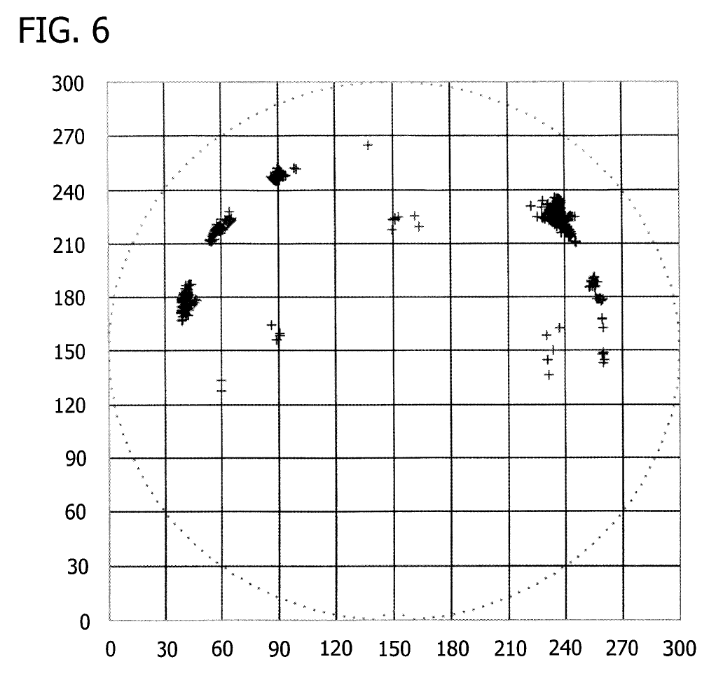

FIG. 5 graphically illustrates a two-dimensional profile of one side of a channel 40 of Platform A. The other side of the channel 40 is substantially a mirror image. Platform A has broken edge margins (only outer edge margin, generally indicated at 44B, is illustrated), whereby a side surface 46B defining the channel 40 meets the top surface generally at a 90 degree edge. Wafer A was supported on Platform A during the above-described annealing process. FIG. 6 graphically illustrates the slip locations in Wafer A created during the annealing process. As is readily apparent from FIG. 6, Platform A caused a significant amount of slip in Wafer A.

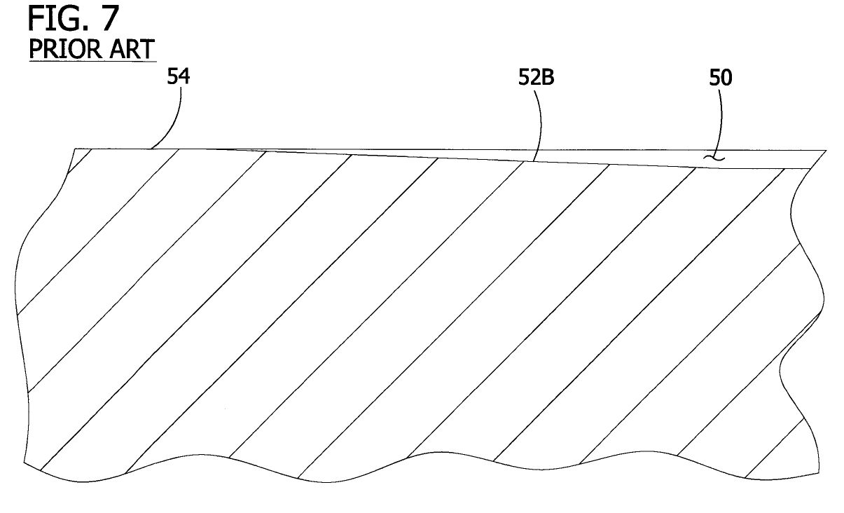

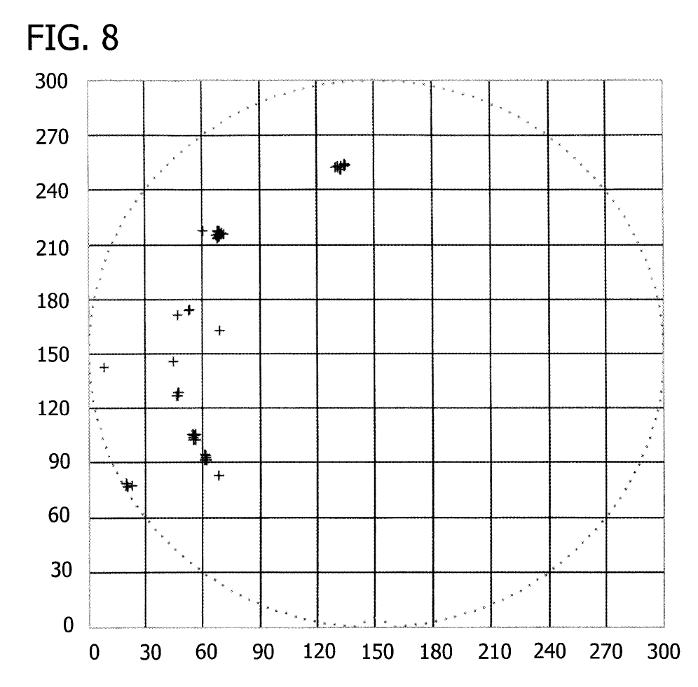

FIG. 7 graphically illustrates a two-dimensional profile of one side of a channel 50 of Platform B. The other side of the channel 50 is substantially a mirror image. The side surfaces (only the outer side surface 52B is illustrated) of Platform B are chamfered and have a constant 2 degree slope. The side surfaces 52B were polished. The side surfaces 52B meet a top surface of the platform at an obtuse angle (i.e., 178 degrees), thus an edge margin 56B is relatively not sharp as compared to the broken edge of FIG. 5. Wafer B was supported on Platform B during the annealing process. FIG. 8 graphically illustrates the slip locations in Wafer B created during the annealing process. As is readily apparent from FIG. 8, Platform B caused a significant amount of slip in Wafer B, albeit generally less slip than incurred by Wafer A.

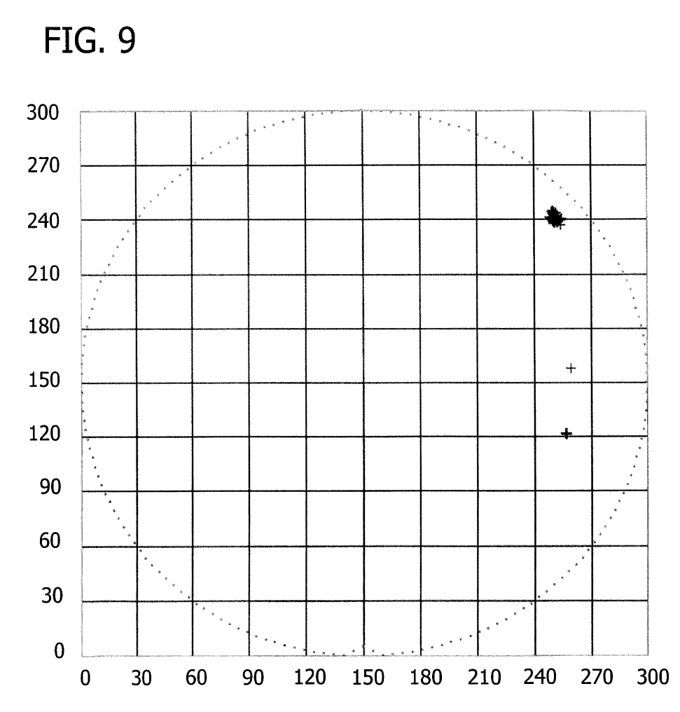

Platform C has a channel with opposite 2 degree chamfered, unpolished side surfaces. Thus edge margins of the channel are substantially the same as Platform B, except that they are not polished. Wafer C was supported on Platform C during the annealing process. FIG. 9 graphically illustrates the slip locations in Wafer C created during the annealing process. As is readily apparent from FIG. 9, Platform C caused a significant amount of slip in Wafer C, albeit less slip than incurred by Wafer B.

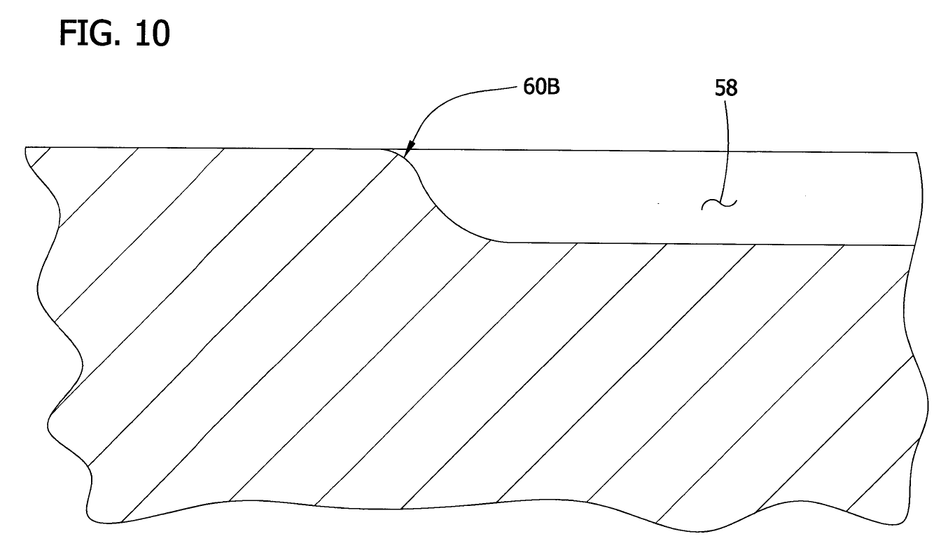

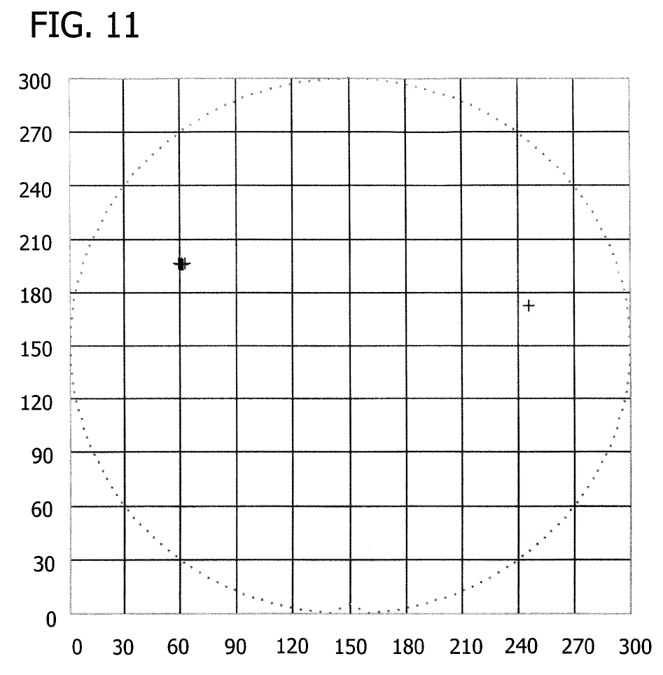

FIG. 10 graphically illustrates a two-dimensional profile of one side of a channel 58 of Platform D. The other side of the channel is substantially a mirror image. Edge margins of the channel 58, the outer edge margin is generally indicated at 60B, are convex and have radii of curvature of about 0.1 mm. Wafer D was supported on Platform D during the annealing process. FIG. 11 graphically illustrates the slip locations in Wafer D created during the annealing process. As is readily apparent from FIG. 11, Platform D caused less slip in Wafer D than the above platforms caused in the respective wafers.

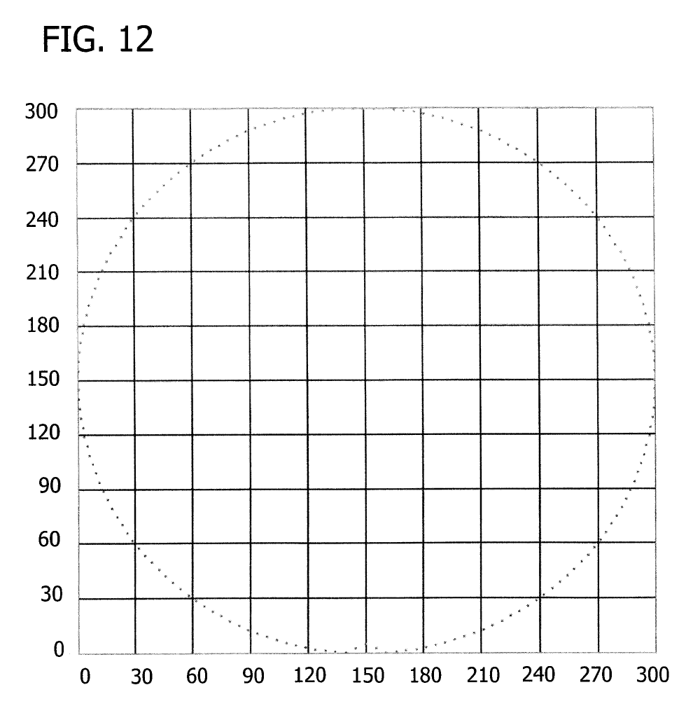

Platform E has convex edge margins having radii of curvature of 0.5 mm, as shown in FIG. 4. Wafer E was supported on Platform E during the annealing process. FIG. 12 graphically illustrates the slip locations in Wafer E created during the annealing process. As is readily apparent from FIG. 12, Platform E caused zero slip in Wafer E.

All variables were held constant during the experiment, except for the edge margins of the channels. Because each of the wafers experienced a different amount of slip, it can be reasonably deduced that the difference in the amount of slip is due to the difference in the edge margins. Thus, it is clear that Platform E having a channel with edge margins having radii of curvature that are about 0.5 mm caused the least amount of slip, and more particularly, caused no slip in the supported wafer. Moreover, because Platform D having a channel with edge margins having radii of curvature of about 0.1 mm caused some slip, and yet the 0.5 mm caused no slip, it may be reasonably induced that a channel having edge margins with radii of curvature that are greater than or equal to about 0.5 mm will cause the least amount and even zero slip in an associated wafer.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that advantageous results are attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A platform for supporting a semiconductor wafer comprising a body having a generally planar top surface sized and shaped for supporting the wafer, and a channel running along the top surface of the body and having a depth extending from the top surface toward the bottom surface of the body, said channel having spaced apart first and second edge margins in contiguous relationship with the top surface of the body, wherein at least one of said edge margins is generally convex along at least a portion of the channel.

2. The platform set forth in claim 1 wherein both of said first and second edge margins of the channel are generally convex along at least a portion of the channel.

3. The platform set forth in claim 2 wherein each of said first and second edge margins has a radius of curvature of at least about 0.1 mm along at least a portion of the channel.

4. The platform as set forth in claim 3 wherein each of said first and second edge margins has a radius of curvature of at least about 0.5 mm along at least a portion of the channel.

5. The platform as set forth in claim 4 wherein each of said first and second edge margins has a radius of curvature of at least about 0.5 mm along substantially an entirety of the channel.

6. The platform as set forth in claim 4 wherein each of said first and second edge margins does not extend above the top surface.

7. The platform as set forth in claim 6 wherein a distance between said first and second edge margins is between about 10 mm to about 15 mm along substantially an entirety of the channel.

8. The platform as set forth in claim 7 wherein the depth of the channel is about 0.2 mm.

9. A support ring for supporting a semiconductor wafer in a vertical wafer boat during an annealing process, the support ring comprising a generally ring-shaped body sized and shaped for reception in the vertical wafer boat, the body having a generally planar top surface sized and shaped for supporting the wafer and a bottom surface, and a channel running along the top surface of the body and having a depth extending from the top surface toward the bottom surface of the body, said channel having radially spaced apart inner and outer edge margins in contiguous relationship with the top surface of the body, wherein at least one of said inner and outer edge margins is generally convex.

10. The support ring as set forth in claim 9 wherein both of said inner and outer edge margins of the channel are generally convex.

11. The support ring as set forth in claim 10 wherein each of said inner and outer edge margins has a radius of curvature of at least about 0.1 mm.

12. The support ring as set forth in claim 11 wherein each of said inner and outer edge margins has a radius of curvature of at least about 0.5 mm.

13. The support ring as set forth in claim 12 wherein each of said first and second edge margins has a radius of curvature of at least about 0.5 mm along substantially an entirety of the channel.

14. The support ring as set forth in claim 12 wherein each of said first and second edge margins does not extend above the top surface.

15. The support ring as set forth in claim 12 wherein said channel is arcuate and is generally concentric with said generally ring-shaped body.

16. The support ring as set forth in claim 15 wherein said generally ring-shaped body includes a radial opening extending from a center opening of the body, said channel having opposite ends extending to the radial opening.

17. The support ring as set forth in claim 15 wherein said generally ring-shaped body has a diameter of about 300 mm.

18. The support ring as set forth in claim 9 in combination with the wafer boat, the wafer boat including rails and fingers for supporting the platform, the body having grooves for receiving the fingers.

19. The support ring as set forth in claim 9 further comprising a silicon oxide layer formed on the top surface of the wafer body.

20. The support ring as set forth in claim 19 wherein the silicon oxide layer has a thickness of between about 25 nanometers and 5 micrometers.
